(19) United States
(12) Patent Application Publication
(10) Pub. No.: US 2024/0150550 A1
(43) Pub. Date: May 9, 2024

(54) ORIENTABLE ETHYLENE VINYL ALCOHOL BLEND

(71) Applicant: Cryovac, LLC, Charlotte, NC (US)

(72) Inventors: Drew V. Speer, Charlotte, NC (US); Dwight Wayne Schwark, Rock Hill, SC (US)

(21) Appl. No.: 18/280,988

(22) PCT Filed: Mar. 9, 2022
(86) PCT No.: PCT/US2022/019484

§ 371 Date: Sep. 8, 2023

Related U.S. Application Data
(60) Provisional application No. 63/158,496, filed on Mar. 9, 2021.

(51) Int. Cl. C08K 5/11; B32B 27/08; B32B 27/18; B32B 27/30; B32B 27/32; B32B 27/36; C08K 5/092; C08K 5/1565

(52) U.S. Cl. CPC C08K 5/11; B32B 27/08; B32B 27/18; B32B 27/306; B32B 27/32; B32B 27/36; C08K 5/092; C08K 5/1565; B29C 48/08; B32B 2250/24; B32B 2270/00; B32B 2307/406; B32B 2307/412; B32B 2307/414; B32B 2307/581; B32B 2307/7244; B32B 2307/736; B32B 2553/00

(57) ABSTRACT

A blend, multilayer film and process for making a multilayer film having improved processability and lower crystallization temperature is disclosed. The blend being at least 90.0% ethylene vinyl alcohol copolymer having a first crystallization temperature; and between (i) processing aid as compared to the barrier layer. The blend having a second crystallization temperature that is at least lower than the first crystallization temperature.

### CROSS-REFERENCE TO RELATED APPLICATIONS

This application claims priority to U.S. Patent Application Ser. No. 63/158,496, filed Mar. 9, 2021 and entitled “Orientable Ethylene Vinyl Alcohol Blend”, the entirety of which is incorporated herein by reference.

### BACKGROUND

The subject matter disclosed herein relates to orientable ethylene vinyl alcohol blends. More particularly, to blends of orientation aids with ethylene vinyl alcohol that improve the processability of ethylene vinyl alcohol while retaining underlying benefits of ethylene vinyl alcohol.

Ethylene vinyl alcohol copolymers are semi-crystalline polymers used in many industries, including food packaging. Ethylene vinyl alcohol copolymers provide good barrier properties and are able to process in the temperature ranges of other polymers. Beyond barrier properties, ethylene vinyl alcohol copolymers are also generally transparent, oil and solvent resistant, flexible, moldable, weather resistant, recyclable, and printable. Ethylene vinyl alcohol copolymers are transparent, stiff, and highly crystalline, provide good gas barrier, and have a relatively high moisture vapor transmission rate. Ethylene vinyl alcohol copolymers are used in coextruded structures for both rigid and flexible packaging. Because of its high crystallinity it can be difficult to thermoform or orient.

Ethylene vinyl alcohol copolymer properties can vary based on the ethylene content. For example, an increase in the ethylene content of ethylene vinyl alcohol copolymers generally improves processability, flexibility, and transparency. However, that increase in ethylene content often decreases the gas barrier properties of the ethylene vinyl alcohol copolymers.

The discussion above is merely provided for general background information and is not intended to be used as an aid in determining the scope of the claimed subject matter.

### BRIEF DESCRIPTION

A blend, multilayer film and process for making a multilayer film having improved processability and lower crystallization temperature is disclosed. The blend being at least 90.0% ethylene vinyl alcohol copolymer having a first crystallization temperature; and between (i) processing aid as compared to the barrier layer. The blend having a second crystallization temperature that is at least lower than the first crystallization temperature.

An advantage that may be realized in the practice of some disclosed embodiments of the multilayer film is improved processability, flexibility, and transparency without substantial detriment to gas barrier properties.

In one exemplary embodiment, a multilayer film is disclosed. The multilayer film comprises a first outer layer, a second outer layer and a barrier layer disposed between the first outer layer and the second outer layer. The barrier layer includes a blend of: at least 90.0% ethylene vinyl alcohol copolymer having a first crystallization temperature; and between (i) 2.0 wt % and 15.0 wt %, (ii) 2.5 wt % and 10.0 wt %, or (iii) 3.0 wt % and 5.0 wt % of a processing aid as compared to the barrier layer. The blend having a second crystallization temperature that is at least 5%, 6%, 7%, 8%, 9%, or 10% lower than the first crystallization temperature as measured by DSC with the following parameters: a) hold for 1.0 min at 30° C.; b) heat from 30.0° C. to 230.0° C. at 10.0° C./min; c) hold for 1.0 min at 230.0° C.; d) cool from 230.0° C. at 10.0° C./min; e) hold for 1.0 min at 30.0° C.; f) Heat from 30.0° C. to 230.0° C. at 10.0° C./min.

In another exemplary embodiment, a blend is disclosed, the blend comprises at least 90.0% ethylene vinyl alcohol copolymer having a first crystallization temperature; and between (i) 2.0 wt % and 15.0 wt %, (ii) 2.5 wt % and 10.0 wt %, or (iii) 3.0 wt % and 5.0 wt % of a processing aid as compared to the barrier layer. The blend having a second crystallization temperature that is at least 5%, 6%, 7%, 8%, 9%, or 10% lower than the first crystallization temperature as measured by DSC with the following parameters: a) hold for 1.0 min at 30° C.; b) heat from 30.0° C. to 230.0° C. at 10.0° C./min; c) hold for 1.0 min at 230.0° C.; d) cool from 230.0° C. at 10.0° C./min; e) hold for 1.0 min at 30.0° C.; f) Heat from 30.0° C. to 230.0° C. at 10.0° C./min.

In another exemplary embodiment, a process for making a multilayer film is disclosed. The method comprises the steps of providing a barrier blend comprising: at least 90.0% ethylene vinyl alcohol copolymer having a first crystallization temperature; and between (i) 2.0 wt % and 15.0 wt %, (ii) 2.5 wt % and 10.0 wt %, or (iii) 3.0 wt % and 5.0 wt % of a processing aid as compared to the barrier layer. The blend having a second crystallization temperature that is at least 5%, 6%, 7%, 8%, 9%, or 10% lower than the first crystallization temperature as measured by DSC with the following parameters: a) hold for 1.0 min at 30° C.; b) heat from 30.0° C. to 230.0° C. at 10.0° C./min; c) hold for 1.0 min at 230.0° C.; d) cool from 230.0° C. at 10.0° C./min; e) hold for 1.0 min at 30.0° C.; f) Heat from 30.0° C. to 230.0° C. at 10.0° C./min. The barrier blend is coextruded to form a multilayer film having a first outer layer, a second outer layer and the barrier blend disposed as a layer between the first outer layer and the second outer layer.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 is a schematic view of a process for making a multilayer film; and

FIG. 2 is a schematic of a hot blown film process for making films.

### DETAILED DESCRIPTION

Ethylene vinyl alcohol is a copolymer of ethylene and vinyl alcohol. Ethylene vinyl alcohol copolymer is prepared by polymerization of ethylene and vinyl acetate to give the ethylene vinyl acetate copolymer followed by hydrolysis. Ethylene vinyl alcohol copolymers are highly crystalline and are produced with various mole % of ethylene content. Ethylene vinyl alcohol is a random copolymer with a chemical structure that is a combination of ethylene and vinyl alcohol units.

Ethylene vinyl alcohol copolymers have a number of beneficial properties.

Ethylene vinyl alcohol copolymers are antistatic and therefore dust accumulation is reduced when used as a surface layer.

Ethylene vinyl alcohol copolymers resins produce a high gloss and low haze, resulting in good optical characteristics.

The —OH group in the molecular chain of ethylene vinyl alcohol copolymers allow for printing on the surface.

Ethylene vinyl alcohol copolymers are resistance to oil and organic solvents.

Ethylene vinyl alcohol copolymers are weather resistance and retain their color. They are resistant to yellowing or becoming opaque.

Ethylene vinyl alcohol copolymers have good gas barrier properties. However, the gas barrier properties depend upon exposure to relative humidity (RH), with increasing humidity diminishing the gas barrier. The barrier properties and humidity sensitivity will vary according to the ethylene content.

Ethylene vinyl alcohol copolymers are commercially available having ethylene contents ranging from 24 to 48 mol %. Ethylene vinyl alcohol copolymers having a higher ethylene content tend to have better processing characteristics. This includes, but is not limited to, orientability, flexibility, thermoformability, elongation, stretch, and shrink. However, the higher ethylene content also results in reduced gas barrier properties to gases such as oxygen, carbon dioxide, carbon monoxide and nitrogen.

On the other hand, ethylene vinyl alcohol copolymers having a lower ethylene content tend to have improved gas barrier properties as compared to the higher ethylene content grades. As a tradeoff, the lower ethylene content ethylene vinyl alcohol copolymers are more difficult to process and may not function in certain applications. Converting processes that require a stretching phase of the material, such as thermoforming or film orientation generally favor ethylene vinyl alcohol copolymer grades with higher ethylene content and thus require a compromise in barrier properties for practical film gauges. Processability is important in film processing methods such as for monolayer film extrusion (blown or cast), co-extruded film extrusion (blown or cast), co-extrusion blow-molding, profile co-extrusion, and coating.

In embodiments described herein, improved processability is achieved by mixing the ethylene vinyl alcohol copolymer with a processing aid. By utilizing a processing aid, good barrier properties remain, while improving processability of ethylene vinyl alcohol copolymers.

The processing aid will typically have at least one ester, carboxylic acid or carbonate functionality and at least one hydroxyl functionality. Processing aids are selected from the group of triacetin, diacetin, lactic acid, triethyl citrate, glycerin and glycerin carbonate. The processing aid is blended with the ethylene vinyl alcohol copolymers in an amount from at least 2.0, 2.5, 3.0, 3.5 or 4.0 wt %. The processing aid is blended with the ethylene vinyl alcohol copolymers in an amount up to 15.0, 14.0, 13.0, 12.0, 11.0, 10.0, 9.0, 8.0, 7.0, 6.0, or 5.0 wt %. The processing aid may be added as a pure substance or incorporated into a masterbatch such that wt % amount is consistent with the ranges described in this paragraph. In embodiments the processing aid is prepared as masterbatch in a first grade of ethylene vinyl alcohol copolymer. In embodiments, the masterbatch is used with a second grade of ethylene vinyl alcohol copolymer.

The processing aid can reduce the crystallization temperature (T_{c}) of the ethylene vinyl alcohol copolymer and slow the crystallization kinetics with limited impact on the ultimate degree of crystallinity. Thus, with the reduced T_{c}, the processing aids allow for a greater percentage of the ethylene vinyl alcohol to be trapped in the amorphous state prior to the stretching phase of the converting process. This results in improved processability of the material while retaining beneficial properties of the ethylene vinyl alcohol copolymer. Additionally, the processing aid may allow for a different crystalline morphology to form which is more amenable to processing such as orientation and thermoforming.

Typically, additives are not blended with ethylene vinyl alcohol copolymers as additional materials tend to decrease the beneficial properties of the ethylene vinyl alcohol. For example, polyamides and ionomers are known to improve processability but also reduce the gas barrier properties. Thus, in embodiments, the blend is relatively pure. In embodiments, the blend is at least 99.0 wt %, 99.1 wt %, 99.2 wt %, 99.3 wt %, 99.4 wt %, 99.5 wt %, 99.6 wt %, 99.6 wt %, 99.8 wt %, 99.9 wt %, or essentially all ethylene vinyl alcohol and processing aid.

Once the ethylene vinyl alcohol copolymer and processing aid are blended, the blend can be used in applications where ethylene vinyl alcohol copolymer are typically used. Uses include, but are not limited to, flexible films, bags, pouches, food packaging, pharmaceutical packaging, heating pipes, automotive plastics. The blend may further be utilized as one or more layers in a multilayer film.

The blended composition of ethylene vinyl alcohol copolymer and processing aid are blended to form a homogenous mixture. An ethylene vinyl alcohol copolymer, or blends of ethylene vinyl alcohol copolymers are provided, the processing aid is blended together with the ethylene vinyl alcohol copolymer(s) to form a homogenous blend. Forming the homogenous blend may be achieved by any suitable method, such as via mixing chambers, single screw extrusion, twin screw extrusion, grinding, pelletizing, melt compounding, screw blending, agitation and the like.

Suitable ethylene vinyl alcohol copolymers in some embodiments include saponified or hydrolyzed ethylene/vinyl acetate copolymers, such as those having a degree of hydrolysis of at least about any of the following values: 50%, 85%, 95%, 99%.

Suitable processing aids in some embodiments have at least one ester, carboxylic acid or carbonate functionality and at least one hydroxyl functionality. In embodiments, the processing aids are selected from the group of triacetin, diacetin, lactic acid, triethyl citrate and glycerin carbonate. The processing aid is blended with the ethylene vinyl alcohol copolymers in an amount from at least 2.0, 2.5, 3.0, 3.5 or 4.0 wt %. The processing aid is blended with the ethylene vinyl alcohol copolymers in an amount up to 15.0, 14.0, 13.0, 12.0, 11.0, 10.0, 9.0, 8.0, 7.0, 6.0, or 5.0 wt %. The processing aid may be added as a pure substance or incorporated into a masterbatch such that wt % amount is consistent with the ranges described in this paragraph. In embodiments the homogenous blend is at least 99.0 wt %, 99.1 wt %, 99.2 wt %, 99.3 wt %, 99.4 wt %, 99.5 wt %, 99.6 wt %, 99.7 wt %, 99.8 wt %, 99.9 wt % or substantially all ethylene vinyl alcohol copolymers and processing aids.

The addition of the processing aid to the ethylene vinyl alcohol copolymers reduce the crystallization temperature (T_{c}) of the ethylene vinyl alcohol copolymer. The reduced T_{c} allows for sufficient percentage of the ethylene vinyl alcohol to be trapped in the amorphous state prior to the stretching phase of the converting process. The slower crystallization kinetics and limited impact on the ultimate degree of crystallinity of the blend as compared to the pure ethylene vinyl alcohol copolymers expands the usefulness of the ethylene vinyl alcohol copolymers.

In embodiments the T_{c} of the homogenous blend is at least 5%, 6%, 7%, 8%, 9%, or 10% lower than the T_{c} of the pure ethylene vinyl alcohol copolymer as measured by DSC with the following parameters: 1) Hold for 1.0 min at 30° C.; 2) Heat from 30.0° C. to 230.0° C. at 10.0° C./min; 3) Hold for 1.0 min at 230.0° C.; 4) Cool from 230.0° C. at 10.0° C./min; 5) Hold for 1.0 min at 30.0° C.; 6) Heat from 30.0° C. to 230.0° C. at 10.0° C./min; 7) Tₘ being taken from second heat.

Crystallinity of the samples is estimated by the enthalpy of the samples measured by DSC. In embodiments, the ΔH_{c} of the blend of the ethylene vinyl alcohol copolymers with processing aid is at least 70%, 75% 80%, 85%, 90%, 95%, 100%, 105%, 110%, 115% or 120% the ΔH_{c} of the ethylene vinyl alcohol copolymers. In embodiments, the ΔHₘ of the blend of the ethylene vinyl alcohol copolymers with processing aid is at least 70%, 75% 80%, 85%, 90%, 95%, 100%, 105%, 110%, 115% or 120% the ΔHₘ of the ethylene vinyl alcohol copolymers.

In embodiments the crystallinity of the homogenous blend is at least 95% of the crystallinity of the pure ethylene vinyl alcohol copolymer as shown by the enthalpy of melting and/or crystallization.

Multilayer Films

In embodiments, the blends described herein are utilized as one or more layers of a multilayer film. As used herein, the term “film” is inclusive of plastic web, regardless of whether it is film or sheet. The film can have a thickness of 0.25 mm or less, or a thickness of from 0.5 to 30 mils, or from 0.5 to 15 mils, or from 1 to 10 mils, or from 1 to 8 mils, or from 1.1 to 7 mils, or from 1.2 to 6 mils, or from 1.3 to 5 mils, or from 1.5 to 4 mils, or from 1.6 to 3.5 mils, or from 1.8 to 3.3 mils, or from 2 to 3 mils, or from 1.5 to 4 mils, or from 0.5 to 1.5 mils, or from 1 to 1.5 mils, or from 0.7 to 1.3 mils, or from 0.8 to 1.2 mils, or from 0.9 to 1.1 mils.

The multilayer films described herein may comprise at least, and/or at most, any of the following numbers of layers: 2, 3, 4, 5, 6, 7, 8, 9, 10, 11, 12, 13, 14 and 15. As used herein, the term “layer” refers to a discrete film component which is substantially coextensive with the film and has a substantially uniform composition. Where two or more directly adjacent layers have essentially the same composition, then these two or more adjacent layers may be considered a single layer for the purposes of this application. In an embodiment, the multilayer film utilizes microlayers. A microlayer section may include between 10 and 1,000 microlayers in each microlayer section.

In embodiments the multilayer shrink film has at least one barrier layer, at least two barrier layers or multiple barrier layers. The barrier layers including ethylene-vinyl alcohol copolymer with an ethylene content of between 24-48 mol %. The multilayer shrink film having a free shrink of at least 60%, 65% and 70% at 85° C. measured in accordance with ASTM D2732.

The multilayer film having an oxygen transmission rate of no more than: 5, 10, 15, 20, 25, 30, 35, 40, 45, 50, 55, 60, 65, 70, 75, 80, 85, 90, 95, 100, 105, 110, 115, 120, 125, 130, 135, 140, 145 or 150 cubic centimeters (at standard temperature and pressure) per square meter per day per 1 atmosphere of oxygen pressure differential measured at 0% relative humidity and 23° C. measured according to ASTM D-3985.

In embodiments the multilayer film has a CO₂/O₂ Transmission Rate ratio (CO₂/O₂ TR ratio) of between 1.0 and 3.5. In embodiments, the multilayer film has a CO₂/O₂ TR ratio of between 1.5 and 3.0. CO₂ Transmission Rate is measured in accordance with ASTM F2476 and 02 Transmission Rate is measured in accordance with ASTM D-3985. Both tested at standard pressure, 73° F. and 0% relative humidity.

In embodiments the multilayer film including a processing aid shows at least 20%. 30%, 40%, 50%, 60%, 70% or 80% increase in the CO₂/O₂ TR ratio as compared to a film made without the processing aid. The comparative film without the processing aid being identical to the multilayer film with the processing aid with the exception of the amount of processing aid is substituted with additional EVOH wt %.

The film comprises at least one barrier layer. As used herein, the term “barrier”, and the phrase “barrier layer”, as applied to films and/or film layers, are used with reference to the ability of a film or film layer to serve as a barrier to one or more gases. Oxygen transmission rate is one method to quantify the effect of a barrier layer. As used herein, the term “oxygen transmission rate” refers to the oxygen transmitted through a film in accordance with ASTM D3985 “Standard Test Method for Oxygen Gas Transmission Rate Through Plastic Film and Sheeting Using a Coulometric Sensor,” which is hereby incorporated, in its entirety, by reference thereto.

The barrier layer includes at least 85 wt %, 86 wt %, 87 wt %, 88 wt %, 89 wt %, 90 wt %, 91 wt %, 92 wt %, 93 wt %, 94 wt %, 95 wt %, 96 wt %, 97 wt %, or 98 wt % of the layer of ethylene-vinyl alcohol copolymer or blends of ethylene-vinyl alcohol copolymers. The barrier layer further includes at least, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, or 15 wt % as compared to the barrier layer of a processing aid. In an embodiment the barrier layers are substantially all ethylene-vinyl alcohol copolymer. The ethylene content of the ethylene-vinyl alcohol copolymer has an effect on the processability of multilayer films and also has an effect on oxygen transmission rate. Generally, lower ethylene content results in a film that has a lower orientability, and may not be processable at certain orientation ratios. A higher ethylene content generally raises the oxygen transmission rate properties.

In other embodiments, the barrier layers are substantially all ethylene-vinyl alcohol copolymer or blends of ethylene-vinyl alcohol copolymers and processing aid. Ethylene-vinyl alcohol copolymers may have an ethylene content of not more than any of the following values: 50%, 48%, 44%, 40%, 38%, 36%, 34%, 32% and 30% all mole percent. In embodiments, the ethylene-vinyl alcohol copolymer or blend of ethylene-vinyl alcohol copolymers resulting in an ethylene content of between 24-48 mol %. Exemplary ethylene-vinyl alcohol copolymers include those having ethylene contents of 24, 27, 29, 32, 35, 38, 44, 48 and 50 mole % and blends thereof.

Ethylene-vinyl alcohol copolymers may include saponified or hydrolyzed ethylene/vinyl acetate copolymers, such as those having a degree of hydrolysis of at least about any of the following values: 50%, 85%, 95%, 95%.

In embodiments the multilayer film includes at least two barrier layers of the same composition. In embodiments, the multilayer film includes at least two barrier layers of distinct compositions. The composition, thickness, and other characteristics of a barrier layers may be substantially the same as any of those of other barrier layers, or may differ from any other barrier layers.

A barrier layers may have a thickness of at least about, and/or at most about, any of the following: 0.05, 0.1, 0.15, 0.2, 0.25, 0.5, 1, 2, 3, 4, and 5 mils. In embodiments the barrier layer is less than 15 wt % of the multilayer film. In other embodiments, the barrier layer is less than 10 wt % of the multilayer film. In yet other embodiments, the barrier layer is less than 5 wt % of the multilayer film.

In one embodiment the outer layers of the films described herein are a sealant layer and a skin layer. In another embodiment both outer layers are skin layers. The first outer layer being the sealant layer and the second outer layer being the skin layer. As used herein, the phrases “seal layer,” “sealing layer,” “heat seal layer,” and “sealant layer,” refer to an outer layer, or layers, involved in the sealing of the film to itself, another layer of the same or another film, and/or another article which is not a film. As used herein, the phrase “skin layer” refers to a film layer having only one of its surfaces directly adhered to another layer of the film and its other surface is exposed to the environment. The primary function of the skin layer is to provide puncture, abuse, thermal and abrasion resistance.

As used herein, the term “heat-seal,” and the phrase “heat-sealing,” refer to any seal of a first region of a film surface to a second region of a film surface, wherein the seal is formed by heating the regions to at least their respective seal initiation temperatures. Heat-sealing is the process of joining two or more thermoplastic films or sheets by heating areas in contact with each other to the temperature at which fusion occurs, usually aided by pressure. The heating can be performed by any one or more of a wide variety of manners, such as using a heated bar, hot wire, hot air, infrared radiation, ultraviolet radiation, electron beam, ultrasonic, and melt-bead. A heat seal is usually a relatively narrow seal (e.g., 0.02 inch to 1 inch wide) across a film. One particular heat sealing means is a heat seal made using an impulse sealer, which uses a combination of heat and pressure to form the seal, with the heating means providing a brief pulse of heat while pressure is being applied to the film by a seal bar or seal wire, followed by rapid cooling of the bar or wire.

Heat seal layers include thermoplastic polymers such as thermoplastic polyolefins and ionomers. In embodiments, polymers for the sealant layer include homogeneous ethylene/alpha-olefin copolymer, heterogeneous ethylene/alpha-olefin copolymer, ethylene homopolymer, ionomer and ethylene/vinyl acetate copolymer. In some embodiments, the heat seal layer can comprise a polyolefin, particularly an ethylene/alpha-olefin copolymer. For example, a polyolefin having a density of from 0.88 g/cc to 0.917 g/cc, or from 0.90 g/cc to 0.917 g/cc, or less than 0.92 g/cc. More particularly, the seal layer can comprise at least one member selected from the group consisting of high density polyethylene, linear low density polyethylene, medium density polyethylene, low density polyethylene, very low density polyethylene, homogeneous ethylene/alpha-olefin copolymer, and polypropylene. “Polymer” herein refers to homopolymer, copolymer, terpolymer, etc. “Copolymer” herein includes copolymer, terpolymer, etc.

As used herein, the term “copolymer” refers to polymers formed by the polymerization of reaction of at least two different monomers. For example, the term “copolymer” includes the co-polymerization reaction product of ethylene and an -olefin, such as 1-octene. The term “copolymer” is also inclusive of, for example, the co-polymerization of a mixture of ethylene, propylene, 1-propene, 1-butene, 1-hexene, and 1-octene. As used herein, a copolymer identified in terms of a plurality of monomers, e.g., “propylene/ethylene copolymer,” refers to a copolymer in which either a monomer may copolymerize in a higher weight or molar percent than the other monomer or monomers. However, the first listed monomer generally polymerizes in a higher weight percent than the second listed monomer.

“High density polyethylene” (HDPE) as used herein has a density of at least 0.950 grams per cubic centimeter.

“Medium density polyethylene” (MDPE) as used herein has a density in the range of from 0.930 to 0.950 grams per cubic centimeter.

“Low density polyethylene” (LDPE) as used herein has a density in the range of from 0.910 to 0.930 grams per cubic centimeter.

“Linear low density polyethylene” (LLDPE) as used herein has a density in the range of from 0.910 to 0.930 grams per cubic centimeter.

“Very low density polyethylene” (VLDPE) as used herein has a density less than 0.915 grams per cubic centimeter.

Unless otherwise indicated, all densities herein are measured according to ASTM D-1505.

As used herein, the term “polyolefin” refers to any polymerized olefin, which can be linear, branched, cyclic, aliphatic, substituted, or unsubstituted. More specifically, included in the term polyolefin are homopolymers of olefin, copolymers of olefin, copolymers of an olefin and an non-olefinic comonomer copolymerizable with the olefin, such as unsaturated ester, unsaturated acid (especially alpha-beta monocarboxylic acids), unsaturated acid anhydride, unsaturated acid metal neutralized salts, and the like. Specific examples include polyethylene homopolymer, polypropylene homopolymer, polybutene, ethylene/alpha-olefin copolymer, propylene/alpha-olefin copolymer, butene/alpha-olefin copolymer, ethylene/vinyl acetate copolymer, ethylene/ethyl acrylate copolymer, ethylene/butyl acrylate copolymer, ethylene/methyl acrylate copolymer, ethylene/acrylic acid copolymer, ethylene/methacrylic acid copolymer, modified polyolefin resin, ionomer resin, polymethylpentene, etc. Modified polyolefin resin is inclusive of modified polymer prepared by copolymerizing the homopolymer of the olefin or copolymer thereof with an unsaturated carboxylic acid, e.g., maleic acid, fumaric acid or the like, or a derivative thereof such as the anhydride, ester or metal salt or the like. It could also be obtained by incorporating into the olefin homopolymer or copolymer, an unsaturated carboxylic acid, e.g., maleic acid, fumaric acid or the like, or a derivative thereof such as the anhydride, ester or metal salt or the like.

As used herein, the phrase “modified polymer,” as well as more specific phrases such as “modified ethylene vinyl acetate copolymer,” and “modified polyolefin” refer to such polymers having an anhydride functionality, as defined immediately above, grafted thereon and/or copolymerized therewith and/or blended therewith. Preferably, such modified polymers have the anhydride functionality grafted on or polymerized therewith, as opposed to merely blended therewith.

In general, the ethylene/alpha-olefin copolymer comprises a copolymer resulting from the copolymerization of from about 80 to 99 weight percent ethylene and from 1 to 20 weight percent alpha-olefin. Preferably, the ethylene alpha-olefin copolymer comprises a copolymer resulting from the copolymerization of from about 85 to 95 weight percent ethylene and from 5 to 15 weight percent alpha-olefin.

As used herein, the phrase “heterogeneous polymer” refers to polymerization reaction products of relatively wide variation in molecular weight and relatively wide variation in composition distribution, i.e., typical polymers prepared, for example, using conventional Ziegler-Natta catalysts. Heterogeneous copolymers typically contain a relatively wide variety of chain lengths and comonomer percentages. Heterogeneous copolymers have a molecular weight distribution (Mw/Mn) of greater than 3.0.

As used herein, the phrase “homogeneous polymer” refers to polymerization reaction products of relatively narrow molecular weight distribution and relatively narrow composition distribution. Homogeneous polymers are useful in various layers of the multilayer heat-shrinkable film. Homogeneous polymers are structurally different from heterogeneous polymers, in that homogeneous polymers exhibit a relatively even sequencing of comonomers within a chain, a mirroring of sequence distribution in all chains, and a similarity of length of all chains, i.e., a narrower molecular weight distribution. Furthermore, homogeneous polymers are typically prepared using metallocene, or other single-site type catalysis, rather than using Ziegler Natta catalysts. Homogeneous polymers have a molecular weight distribution (Mw/Mn) of less than 3.0 More particularly, homogeneous ethylene/alpha-olefin copolymers may be characterized by one or more methods known to those of skill in the art, such as molecular weight distribution (M_{w}/Mₙ), composition distribution breadth index (CDBI), narrow melting point range, and single melt point behavior. The molecular weight distribution (M_{w}/Mₙ), also known as “polydispersity,” may be determined by gel permeation chromatography. In some embodiments, the homogeneous ethylene/alpha-olefin copolymers have an M_{w}/Mₙ of less than 2.7; in another embodiment from about 1.9 to 2.5; and it yet another embodiment, from about 1.9 to 2.3. The composition distribution breadth index (CDBI) of such homogeneous ethylene/alpha-olefin copolymers will generally be greater than about 70 percent. The CDBI is defined as the weight percent of the copolymer molecules having a comonomer content within 50 percent (i.e., plus or minus 50%) of the median total molar comonomer content. The CDBI of linear polyethylene, which does not contain a comonomer, is defined to be 100%. The Composition Distribution Breadth Index (CDBI) is determined via the technique of Temperature Rising Elution Fractionation (TREF). CDBI determination clearly distinguishes homogeneous copolymers (i.e., narrow composition distribution as assessed by CDBI values generally above 70%) from very low density polyethylenes available commercially which generally have a broad composition distribution as assessed by CDBI values generally less than 55%. TREF data and calculations therefrom for determination of CDBI of a copolymer is readily calculated from data obtained from techniques known in the art, such as, for example, temperature rising elution fractionation as described, for example, in Wild et. al., J. Poly. Sci. Poly. Phys. Ed., Vol. 20, p. 441 (1982). In some embodiments, homogeneous ethylene/alpha-olefin copolymers have a CDBI greater than about 70%, i.e., a CDBI of from about 70% to 99%. In general, homogeneous ethylene/alpha-olefin copolymers useful in the present invention also exhibit a relatively narrow melting point range, in comparison with “heterogeneous copolymers”, i.e., polymers having a CDBI of less than 55%. In an embodiment, the homogeneous ethylene/alpha-olefin copolymers exhibit an essentially singular melting point characteristic, with a peak melting point (Tₘ), as determined by Differential Scanning Colorimetry (DSC), of from about 60° C. to 105° C. In an embodiment, the homogeneous copolymer has a DSC peak Tₘ of from about 80° C. to 100° C. As used herein, the phrase “essentially single melting point” means that at least about 80%, by weight, of the material corresponds to a single Tₘ peak at a temperature within the range of from about 60° C. to 105° C., and essentially no substantial fraction of the material has a peak melting point in excess of about 115° C., as determined by DSC analysis. DSC measurements are made on a Perkin Elmer System 7 Thermal Analysis System. Melting information reported are second melting data, i.e., the sample is heated at a programmed rate of 10° C./min to a temperature below its critical range. The sample is then reheated (2nd melting) at a programmed rate of 10° C./min.

A homogeneous ethylene/alpha-olefin copolymer can, in general, be prepared by the copolymerization of ethylene and any one or more alpha-olefin. In certain embodiments, the alpha-olefin is a C₃-C₂₀ alpha-monoolefin, a C₄-C₁₂ alpha-monoolefin, a C₄-C₈ alpha-monoolefin. In an embodiment, the alpha-olefin copolymer comprises at least one member selected from the group consisting of butene-1, hexene-1, and octene-1, i.e., 1-butene, 1-hexene, and 1-octene, respectively. In an embodiment, the alpha-olefin copolymer comprises octene-1, and/or a blend of hexene-1 and butene-1. In another embodiment, the alpha-olefin copolymer comprises a blend of at least two of octene-1, hexene-1 and butene-1.

In an embodiment, the heat seal layer is mainly composed of polyolefin. In an embodiment, the heat seal layer has a total polyolefin content of from 90 to 99 wt % based on the total composition of the heat seal layer. In other embodiments, the heat seal layer is composed solely of polyolefin(s).

In an embodiment, the heat seal layer has a melting point less than any of the following values: 220° C., 210° C., 200° C., 190° C., 180° C., 170° C., 160° C., 150° C., 140° C. and 130° C.; and the melting point of the heat seal layer may be at least any of the following values: 90° C., 100° C., 110° C., 120° C., 130° C., 140° C., and 150° C. In an embodiment, the heat seal layer comprises from 80 to 99 wt % of a linear low density polyethylene copolymer having a melting point between 90-130° C. In an embodiment, the heat seal layer comprises from 80 to 99 wt % of a very low density polyethylene copolymer having a melting point between 85-125° C. All references to the melting point of a polymer, a resin, or a film layer in this application refer to the melting peak temperature of the dominant melting phase of the polymer, resin, or layer as determined by differential scanning calorimetry according to ASTM D-3418.

In embodiments where the heat seal layer comprises amorphous material, then the heat seal layer may not clearly display a melting point. The glass transition temperature for the heat seal layer may be less than, and may range between, any of the following values: 125° C., 120° C., 110° C., 100° C., 90° C., 80° C., 70° C., 60° C., and 50° C.; measured where the relative humidity may be any of the following values: 100%, 75%, 50%, 25%, and 0%. All references to the glass transition temperature (T_{g}) of a polymer was determined by the Perkin Elmer “half Cp extrapolated” (the “half Cp extrapolated” reports the point on the curve where the specific heat change is half of the change in the complete transition) following the ASTM D3418 “Standard Test Method of Transition Temperatures of Polymers by Thermal Analysis,” which is hereby incorporated, in its entirety, by reference thereto.

In an embodiment the heat seal layer has a melt index or composite melt index of at least 0.5, 1.0, 1.5, 2.0, 2.5, 3.0, 3.5, 4.0, 4.5 and 5.0 g/10 min @190° C. and 2.16 kg measured in accordance with ASTM D1238.

The thickness of the heat seal layer may be selected to provide sufficient material to cause a strong heat seal bond, yet not so thick so as to negatively affect the characteristics of the film to an unacceptable level. The heat seal layer may have a thickness of at least any of the following values: 0.05 mils, 0.1 mils, 0.15 mils, 0.2 mils, 0.25 mils, 0.3 mils, 0.35 mils, 0.4 mils, 0.45 mils, 0.5 mils, and 0.6 mils. The heat seal layer may have a thickness less than any of the following values: 5 mils, 4 mils, 3 mils, 2 mils, 1 mil, 0.7 mils, 0.5 mils, and 0.3 mils. The thickness of the heat seal layer as a percentage of the total thickness of the film may be less that any of the following values: 50%, 40%, 30%, 25%, 20%, 15%, 10%, and 5%; and may range between any of the forgoing values (e.g., from 10% to 30%).

The skin layer is film layer having only one of its surfaces directly adhered to another layer of the film and its other surface is exposed to the environment. The primary function of the skin layer is to provide puncture, abuse, thermal and abrasion resistance.

As used herein, the phrase “directly adhered,” as applied to film layers, is defined as adhesion of the subject film layer to the object film layer, without a tie layer, adhesive, or other layer therebetween. In contrast, as used herein, the word “between,” as applied to a film layer expressed as being between two other specified layers, includes both direct adherence of the subject layer between to the two other layers it is between, as well as including a lack of direct adherence to either or both of the two other layers the subject layer is between, i.e., one or more additional layers can be imposed between the subject layer and one or more of the layers the subject layer is between.

The thickness of the skin layer may be selected to provide sufficient abuse resistance. The skin layer may have a thickness of at least any of the following values: 0.05 mils, 0.1 mils, 0.15 mils, 0.2 mils, 0.25 mils, 0.3 mils, 0.35 mils, 0.4 mils, 0.45 mils, 0.5 mils, and 0.6 mils. The skin layer may have a thickness less than any of the following values: 5 mils, 4 mils, 3 mils, 2 mils, 1 mil, 0.7 mils, 0.5 mils, and 0.3 mils. The thickness of skin layer as a percentage of the total thickness of the film may be less that any of the following values: 50%, 40%, 30%, 25%, 20%, 15%, 10%, and 5%; and may range between any of the forgoing values (e.g., from 10% to 30%).

In embodiments, the skin layer comprises polyolefin, polypropylene copolymer, polyolefin block copolymer or blends thereof. In some embodiments, the skin layer is predominately polypropylene copolymer. In embodiments, the skin layer includes at least 60 wt %, 65 wt %, 70 wt %, 75 wt %, 80 wt %, 85 wt %, 90 wt %, 95 wt % or substantially all polypropylene copolymer. In embodiments the skin layer includes at least 40 wt %, 45 wt %, 50 wt %, 55 wt % 60 wt %, 65 wt %, 70 wt %, 75 wt %, 80 wt %, 85 wt %, 90 wt %, 95 wt % or substantially all linear low density polyethylene, very low density polyethylene, or blends thereof.

The film may comprise one or more intermediate layers, such as a tie layers, bulk layers or abuse layers. In addition to a first intermediate layer, the film may comprise a second intermediate layer. “Intermediate” herein refers to a layer of a multi-layer film which is between an outer layer and an inner layer of the film. “Inner layer” herein refers to a layer which is not an outer or surface layer, and has both of its principal surfaces directly adhered to another layer of the film. “Outer layer” herein refers to any film layer of film having less than two of its principal surfaces directly adhered to another layer of the film. All multilayer films have two, and only two, outer layers, each of which has a principal surface adhered to only one other layer of the multilayer film. In monolayer films, there is only one layer, which, of course, is an outer layer in that neither of its two principal surfaces are adhered to another layer of the film. “Outer layer” also is used with reference to the outermost layer of a plurality of concentrically arranged layers of a seamless tubing, or the outermost layer of a seamed film tubing.

The intermediate layer may have a thickness of at least about, and/or at most about, any of the following: 0.05, 0.1, 0.15, 0.2, 0.25, 0.5, 1, 2, 3, 4, and 5 mils. The thickness of the intermediate layer as a percentage of the total thickness of the film may be at least about, and/or at most about, any of the following: 1, 3, 5, 7, 10, 15, 20, 25, 30, 35, 40, 45, and 50 percent.

Thermoplastic Film-Forming

The blend may be used to make a film that is manufactured by thermoplastic film-forming processes known in the art. The film may be prepared by extrusion or coextrusion utilizing, for example, a tubular trapped bubble film process, double bubble or triple bubble orientation process or a flat film (i.e., cast film or slit die) process. The film may also be prepared by applying one or more layers by extrusion coating, adhesive lamination, extrusion lamination, solvent-borne coating, or by latex coating (e.g., spread out and dried on a substrate). A combination of these processes may also be employed.

Heat Shrink Film

In embodiments the film is a heat shrinkable film. The film can be produced by carrying out only monoaxial orientation, or by carrying out biaxial orientation. As used herein, the phrase “heat-shrinkable” is used with reference to films which exhibit a total free shrink (i.e., the sum of the free shrink in both the machine and transverse directions) of at least 10% at 185° F., as measured by ASTM D 2732, which is hereby incorporated, in its entirety, by reference thereto. All films exhibiting a total free shrink of less than 10% at 185° F. are herein designated as being non-heat-shrinkable. The heat-shrinkable film can have a total free shrink at 1850° F. of at least 15%, or at least 20%, or at least 30%, or at least 40%, or at least 45%, or at least 50%, or at least 55%, or at least 60%, or at least 65%, or at least 70%, as measured by ASTM D 2732. Heat shrinkability can be achieved by carrying out orientation in the solid state (i.e., at a temperature below the melt temperature of the polymer). The film may be oriented in either the machine (i.e., longitudinal), the transverse direction, or in both directions (i.e., biaxially oriented), for example, to enhance the strength, optics, and durability of the film. A web or tube of the film may be uniaxially or biaxially oriented by imposing a draw force at a temperature where the film is softened (e.g., above the vicat softening point; see ASTM 1525) but at a temperature below the film's melting point. The film may then be quickly cooled to retain the physical properties generated during orientation and to provide a heat-shrink characteristic to the film. The film may be oriented using, for example, a tenter-frame process or a bubble process (double bubble, triple bubble and likewise). These processes are known to those of skill in the art, and therefore are not discussed in detail here. The total orientation factor employed (i.e., stretching in the transverse direction and drawing in the machine direction) can be any desired factor, such as at least 2×, at least 3×, at least 4×, at least 5×, at least 6×, at least 7×, at least 8×, at least 9×, at least 10×, at least 16×, at least 22×, at least 30×, or from 1.5× to 20×, from 2× to 16×, from 3× to 12×, or from 4× to 9×.

Crosslinking

One or more of the layers of the film—or at least a portion of the entire film—may be cross-linked, for example, to improve the strength or change the melt or softening characteristics of the film. Cross-linking may be achieved by using chemical additives or by subjecting one or more film layers to one or more energetic radiation treatments—such as ultraviolet, or ionizing radiation such as X-ray, gamma ray, beta ray, and high energy electron beam treatment—to induce cross-linking between molecules of the irradiated material. Useful ionizing radiation dosages include at least about, and/or at most about, any of the following: 5, 7, 10, 15, 20, 25, 30, 35, 40, 45, 50, 55, 60, 65, 70, 75, 80, 90, 100, 110, 120, 130, and 150 kGy (kiloGray). In embodiments the film is not cross-linked. The cross-linking may occur before the orientation process, for example, to enhance the film strength before orientation, or the cross-linking may occur after the orientation process.

It may be desirable to avoid irradiating one or more film layers. To that end, one or more layers may be extruded and irradiated, and subsequent layers may then be applied to the irradiated substrate, for example, by an extrusion coating process. This will produce an extrusion coating interface, with at least one layer substantially devoid of crosslinks.

Optical Properties

Film transparency (also referred to herein as film clarity) was measured in accordance with ASTM D 1746-97 “Standard Test Method for Transparency of Plastic Sheeting”, published April, 1998, which is hereby incorporated, in its entirety, by reference thereto. The results are reported herein as “percent transparency”. The multilayer, heat-shrinkable film can exhibit a transparency of at least 15 percent, or at least 20 percent, or at least 25 percent, or at least 30 percent, measured using ASTM D 1746-97.

Film haze values were measured in accordance with ASTM D 1003-00 “Standard Test Method for Haze and Luminous Transmittance of Transparent Plastics”, published July 2000, which is hereby incorporated, in its entirety, by reference thereto. The results are reported herein as “percent haze”. The multilayer, heat-shrinkable film can exhibit a haze of less than 7.5 percent, or less than 7 percent, or less than 6 percent, measured using ASTM D 1003-00.

Film gloss values were measured in accordance with ASTM D 2457-97 “Standard Test Method for Specular Gloss of Plastic Films and Solid Plastics”, published Jan. 10, 1997, which is hereby incorporated, in its entirety, by reference thereto. The results are reported herein as “percent gloss”. The film can exhibit a gloss, as measured using ASTM D 2457-97, of from 60% to 100%, or from 70% to 90%.

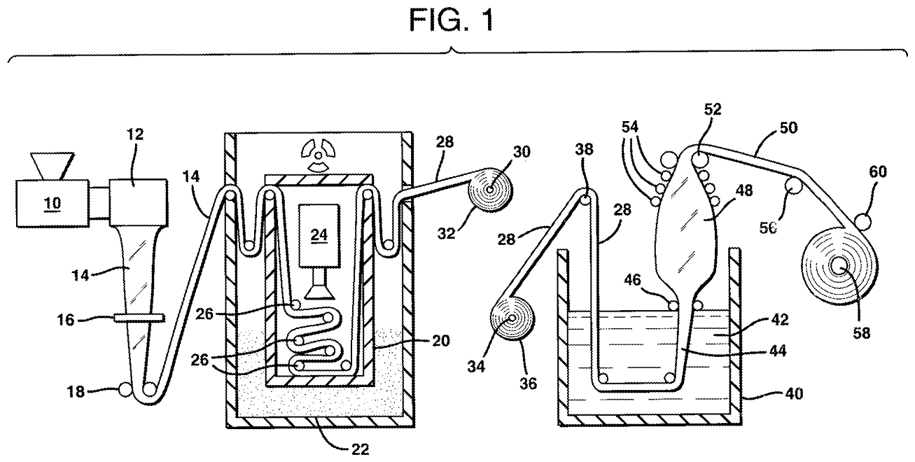

FIG. 1 illustrates a process for making a film. In the process illustrated in FIG. 1, various polymeric formulations solid polymer beads (not illustrated) are fed to a plurality of extruders (for simplicity, only one extruder is illustrated). Inside extruders 10, the polymer beads are degassed, following which the resulting bubble-free melt is forwarded into die head 12, and extruded through an annular die, resulting in tubing tape 14 which is from about 15 to 30 mils thick, and has a lay-flat width of from about 2 to 10 inches.

After cooling or quenching by water spray from cooling ring 16, tubing tape 14 is collapsed by pinch rolls 18, and is thereafter fed through irradiation vault 20 surrounded by shielding 22, where tubing 14 is irradiated with high energy electrons (i.e., ionizing radiation) from iron core transformer accelerator 24. Tubing 14 is guided through irradiation vault 20 on rolls 26. In embodiments, tubing tape 14 is irradiated to a level of from about 20-100 kGy, resulting in irradiated tubing 28. Irradiated tubing tape 28 is wound upon windup roll 30 upon emergence from irradiation vault 20, forming irradiated tubing tape coil 32.

After irradiation and windup, windup roll 30 and irradiated tubing tape coil 32 are removed and installed as unwind roll 34 and unwind tubing tape coil 36, on a second stage in the process of making the tubing film as ultimately desired. Irradiated tubing 28, being unwound from unwind tubing tape coil 36, is then passed over guide roll 38, after which irradiated tubing 28 is passed through hot water bath tank 40 containing hot water 42. Irradiated tubing 28 is then immersed in hot water 42 (preferably having a temperature of about 85° C. to 99° C.) for a period of about 20 to 60 seconds, i.e., for a time period long enough to bring the film up to the desired temperature for biaxial orientation. Thereafter, hot, irradiated tubular tape 44 is directed through nip rolls 46, and bubble 48 is blown, thereby transversely stretching hot, irradiated tubular tape 44 so that oriented film tube 50 is formed. Furthermore, while being blown, i.e., transversely stretched, nip rolls 52 have a surface speed higher than the surface speed of nip rolls 46, thereby resulting in longitudinal orientation. As a result of the transverse stretching and longitudinal drawing, oriented film tube 50 is produced, this blown tubing preferably having been both stretched in a ratio of from about 1:1.5 to 1:6, and drawn in a ratio of from about 1:1.5 to 1:6. More preferably, the stretching and drawing are each performed at a ratio of from about 1:2 to 1:4. The result is a biaxial orientation of from about 1:2.25 to 1:36, more preferably, 1:4 to 1:16. While bubble 48 is maintained between nip rolls 46 and 52, blown film tube 50 is collapsed by converging pairs of parallel rollers 54, and thereafter conveyed through nip rolls 52 and across guide roll 56, and then rolled onto wind-up roll 58. Idler roll 60 assures a good wind-up.

The resulting multilayer film can be used to form bags, casings, thermoformed articles and lidstocks therefor, etc., which, in turn, can be used for the packaging of food-containing products. While various embodiments are illustrated and described herein, other packaging structures, such as resealable bags, side seal bags, vertical form filled bags, vertical pouch packaging, end seal bags, lap seal bags and the like are contemplated.

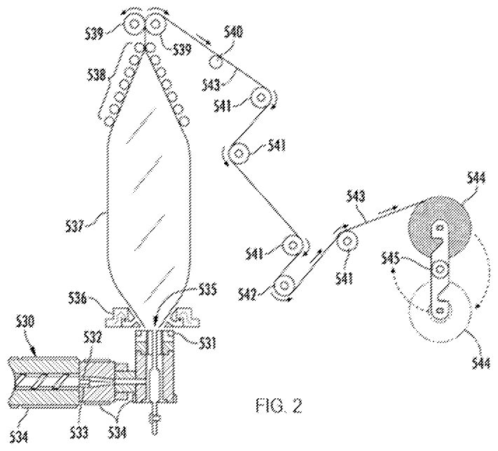

In embodiments, a film is produced by the blown film process illustrated in FIG. 2, which illustrates a schematic view of a process for making a “hot-blown” film, which is oriented in the melt state, and therefore is not heat-shrinkable. Although only one extruder 139 is illustrated in FIG. 2, it is understood that more than one extruder can be utilized to make the films.

In the process of FIG. 2, extruder 530 supplied molten polymer to annular die 531 for the formation of the film, which can be monolayer or multilayer, depending upon the design of the die and the arrangement of the extruder(s) relative to the die, as known to those of skill in the art. Extruder 530 was supplied with polymer pellets suitable for the formation of the film. Extruder 530 subjected the polymer pellets to sufficient heat and pressure to melt the polymer and forward the molten stream through annular die 531.

Extruder 530 was equipped with screen pack 532, breaker plate 533, and heaters 534. The film was extruded between mandrel 535 and die 531, with the resulting extrudate being cooled by cool air from air ring 536. The molten extrudate was immediately blown into blown bubble 537, forming a melt oriented film. The melt oriented film cooled and solidified as it was forwarded upward along the length of bubble 537. After solidification, the film tubing passed through guide rolls 538 and was collapsed into lay-flat configuration by nip rolls 539. The collapsed film tubing was optionally passed over treater bar 540, and thereafter over idler rolls 541, then around dancer roll 542 which imparted tension control to collapsed film tubing 543, after which the collapsed film tubing 543 was wound up as roll 544 via winder 545.

All references to (and incorporations by reference of) ASTM protocols are to the most-recently published ASTM procedure as of the priority (i.e., original) filing date of this patent application in the United States Patent Office unless stated otherwise.

### EXAMPLES

TABLE 1
Identity of Resins Used in Examples

| | | | | | | Melt |
|---|---|---|---|---|---|---|
| | | | | | | flow rate |
| | | | | | | g/10 min |
| | | | Trade | Ethylene | Density | (190° C./ |
| Code | Generic Name | Vendor | Name | Content | g/cm3 | 02.16 kg) |
| | | | | | ASTM | ASTM |
| | | | | | D1238 | D1238 |
| EVOH1 | Ethylene/Vinyl | Kuraray | EVAL | 38 mol % | 1.17 | 1.7 |
| | Alcohol Copolymer | | H171B | | | |
| EVOH2 | Ethylene/Vinyl | Kuraray | EVAL XEP | 38 mol % | 1.17 | 1.7 |
| | Alcohol Copolymer | | 1393B | | | |
| EVOH3 | Ethylene/Vinyl | Mitsubishi | G-Soarnol | 38 mol % | 1.15 | 3.8 |
| | Alcohol Copolymer | Chemical | GH3804B | | | |
| | | Corporation | | | | |
| EVOH4 | Ethylene/Vinyl | Nippon | SOARNOL | 38 mol % | 1.17 | |
| | Alcohol Copolymer | Gohsei | ET3803 | | | |
| EVOH5 | Ethylene/Vinyl | Kuraray | EVAL | 48 mol % | 1.12 | 6.25 |
| | Alcohol Copolymer | | g176B | | | |
| EVOH6 | Ethylene/Vinyl | Kuraray | EVAL | 32 mol % | 1.19 | 1.6 |
| | Alcohol Copolymer | | F171B | | | |
| EVOH7 | Ethylene/Vinyl | Kuraray | Eval | 27 mol % | 1.21 | 4.0 |
| | Alcohol Copolymer | | L171B | | | |
| VLDPE | Very Low Density | | | | | |
| | Polyethylene | | | | | |
| | Copolymer | | | | | |
| VLDPE-md | Maleic Anhydride- | | | | | |
| | Modified Very Low | | | | | |
| | Density Polyethylene | | | | | |
| | Copolymer | | | | | |
| LLDPE | Linear Low Density | | | | | |
| | Polyethylene | | | | | |
| LLDPE-md | Maleic Anhydride- | | | | 0.919 | 2.3 |
| | Modified Linear | | | | | |
| | Low Density | | | | | |
| | Polyethylene | | | | | |
| EVA | Ethylene/Vinyl | | | | | |
| | Acetate Copolymer | | | | | |
| EPC | Propylene/Ethylene | | | | | |
| | Copolymer | | | | | |
| EMA-md | Maleic Anhydride- | | | | | |
| | Modified | | | | | |
| | Ethylene/Methyl | | | | | |
| | Acrylate Copolymer | | | | | |
| PA-6 | Polyamide - 6 | | | | 1.13 | |
| PA-6\66 | Polyamide - 6/66 | | | | 1.12 | |
| PET | Polyethylene | | | | | |
| | Terephthalate | | | | | |
| PP | Polypropylene | | | | | 34 |
| | Homopolymer | | | | | |
| AB | Antiblock and Slip | | | | | |
| | in polyethylene | | | | | |

The processing aids were selected and blended into ethylene vinyl alcohol copolymer having using an Intelli-Torque mixing chamber to create a homogenous mixture. DSC measurements of the blended samples were obtained. The ability to determine transition temperatures and enthalpies makes DSC a valuable tool in producing phase diagrams for various chemical systems. The transition from amorphous solid to crystalline solid is an exothermic process, and results in a peak in the DSC signal. As the temperature increases the sample eventually reaches its melting temperature (Tₘ). The melting process results in an endothermic peak in the DSC curve. Delta H is the enthalpy and crystallization temperature (T_{c}) are recorded. All measurements were acquired via the following method:
Hold for 1.0 min at 30° C.
Heat from 30.0° C. to 230.0° C. at 10.0° C./min.
Hold for 1.0 min at 230.0° C.
Cool from 230.0° C. at 10.0° C./min.
Hold for 1.0 min at 30.0° C.
Heat from 30.0° C. to 230.0° C. at 10.0° C./min.
Tₘ being taken from second heat.

TABLE 2
DSC of Various Additives

| EVOH | Sample | Additive | Tc (° C.) | ΔH_{c}(J/g) | Tm (° C.) | ΔHₘ(J/g) |
|---|---|---|---|---|---|---|
| EVOH1 | 1 | none | 148.6 | 55 | 171.9 | 48.5 |
| | (Control) | | | | | |
| EVOH1 | 2 | 3% triacetin | 136.7 | 58.5 | 163.6 | 58.7 |
| EVOH1 | 3 | 3% lactic acid | 141.5 | 58.8 | 166.1 | 56.7 |
| EVOH1 | 4 | 3% triethyl citrate | 137.3 | 62.2 | 164.3 | 57.0 |
| EVOH1 | 5 | 3% Glycerin carbonate | 137.4 | 73.6 | 164.7 | 59.2 |
| EVOH1 | 6 (C) | 3% propylene glycol | 148.5 | 63.6 | 171.8 | 60.7 |
| EVOH1 | 7 (C) | 3% 2-acetyl triethyl | 148.7 | 65 | 171.7 | 58.6 |
| | | citrate | | | | |
| EVOH1 | 8 (C) | 3% PEG 400 | 148.2 | 65.3 | 170.8 | 59.8 |
| EVOH1 | 9 (C) | PEG 200 | 147.7 | 67.6 | 171 | 61 |
| EVOH1 | 10 (C) | PEG 4000 | 149 | 63 | 171.3 | 59.1 |
| EVOH1 | 11 (C) | 3% racemic lactide | 105.5 | 40.4 | 144.8 | 32.8 |
| EVOH6 | 12 | None | 158 | | 183 | |
| | (Control) | | | | | |
| EVOH7 | 13 | None | 164 | | 60 | 191 |
| | (Control) | | | | | |
| EVOH7 | 14 | 11.7% triacetin | 137.6 | 43.0 | 168.6 | 48.6 |
| EVOH1 | 15 | 3% diacetin | 138.5 | 50.8 | 168.3 | 51.8 |
| EVOH1 | 16 | 2.5% triacetin, | 140.5 | 55.4 | 170 | 58.6 |
| | | 0.5% glycerol | | | | |
| EVOH1 | 17 | 2.5% glycerol, | 141.4 | 63.7 | 168.3 | 64.7 |
| | | 0.5% triacetin | | | | |

(C)=Comparative

Sample 1-4 demonstrated that the additive resulted in a reduction in the crystallization temperature (T_{c}) while maintaining or enhancing overall crystallinity. This is unexpected as similar additives do not demonstrate similar effects on T_{c} and overall crystallinity. For example, as shown in Sample 6, propylene glycol had no effect of T_{c} despite being structurally similar to glycerin carbonate. Likewise, as shown in Sample 7, 2-acetyl triethyl citrate also had no effect on T_{c} despite being of a very similar structurally to triethyl citrate. Furthermore, polyethylene glycol of various molecular weights as used in Samples 8-10 had essentially no effect on T_{c}. Even though racemic lactide is of very similar structure to lactic acid, Sample 9 while having an effect on T_{c} had a negative impact on the overall crystallinity of the structure.

TABLE 3
DSC of Various Additive loading

| | | | MI | | | | | |
|---|---|---|---|---|---|---|---|---|
| | | | (g/10 min., | | | | | |
| | | | 2.16 kg @ | T_{c} | | T_{g} | Tₘ | |
| EVOH | Sample | Additive | 190° C. | (° C.) | ΔH_{c}(J/g) | (° C.) | (° C.) | ΔHₘ(J/g) |
| EVOH1 | 12 | None | 1.7 | 148.6 | 55 | 56 | 171.9 | 48.5 |
| EVOH2 | 13 | None | 1.7 | 132.8 | 46 | 57 | 160.7 | 36.3 |
| EVOH3 | 14 | None | 3.8 | 125.8 | 51.2 | 56.1 | 158 | 44.7 |
| EVOH4 | 15 | None | | 152 | | 58 | 173 | |
| EVOH2 | 16 | 3% triacetin | 1.33 | 121.4 | 41.8 | 54 | 152 | 36.9 |
| EVOH3 | 17 | 3% triacetin | 2.81 | 118.7 | 43.1 | 53.4 | 152.5 | 36.6 |
| EVOH2 | 18 | 15% triacetin | 5.17 | 97.6 | 31.8 | | 140.3 | 29.2 |
| EVOH1 | 19 | 7% triacetin | 2.6 | 126.4 | 53.1 | 52.4 | 154.7 | 37.9 |
| EVOH4 | 20 | 7% triacetin | 2.7 | 123.2 | 51.4 | 53.1 | 155.3 | 43.2 |

Various EVOH resins were used as controls for sample 12-15. Samples 16-20 demonstrate lowered T_{c} for various additive loading. Crystallinity of the samples is estimated by the enthalpy of the samples measured by DSC. In embodiments, the ΔH_{c} of the blend of the EVOH with processing aid is at least 70%, 75% 80%, 85%, 90%, 95%, 100%, 105%, 110%, 115% or 120% the ΔH_{c} of the EVOH. In embodiments, the ΔHₘ of the blend of the EVOH with processing aid is at least 70%, 75%, 80%, 85%, 90%, 95%, 100%, 105%, 110%, 115% or 120% the ΔHₘ of the EVOH.

Multilayer Film Examples

To demonstrate the improved film properties two films were made in a double bubble process having the same composition and layer thickness, with the exception of the barrier layer. Table 4 lists the films with all % being wt % within the layer. Layer 4 of Film 2 was made using 50% EVOH1 and 50% of a masterbatch of containing 16% triacetin and 84% EVOH1.

TABLE 4

| | Layer 1 | Layer 2 | Layer 3 | Layer 4 | Layer 5 | Layer 6 | Layer 7 | Layer 8 | Layer 9 | Layer 10 |
|---|---|---|---|---|---|---|---|---|---|---|
| Film 1 (C) | 80% | 50% | 80% | 60% | 80% | 50% | 50% | 80% | 100% | 100% |
| | VLDPE | VLDPE | VLDPE- | EVOH3 | VLDPE- | VLDPE | VLDPE | VLDPE- | EMA- | PET |
| | | | md | | md | | | md | md | |
| 1.77 mils | 20% | 50% | 20% | 40% | 20% | 50% | 50% | 20% | | |
| | LLDPE | EVA | VLDPE | EVOH5 | VLDPE | EVA | EVA | VLDPE | | |
| Thickness | 0.35 | 0.27 | 0.14 | 0.14 | 0.11 | 0.27 | 0.14 | 0.07 | 0.11 | 0.18 |
| (mils) | | | | | | | | | | |
| Film 2 | 80% | 50% | 80% | 8% | 80% | 50% | 50% | 80% | 100% | 100% |
| | VLDPE | VLDPE | VLDPE- | triacetin | VLDPE- | VLDPE | VLDPE | VLDPE- | EMA- | PET |
| | | | md | | md | | | md | md | |
| 1.77 mils | 20% | 50% | 20% | 92% | 20% | 50% | 50% | 20% | | |
| | LLDPE | EVA | VLDPE | EVOH1 | VLDPE | EVA | EVA | VLDPE | | |
| Thickness | 0.35 | 0.27 | 0.14 | 0.14 | 0.11 | 0.27 | 0.14 | 0.07 | 0.11 | 0.18 |
| (mils) | | | | | | | | | | |

Free shrink of Films 1 and 2 were takin in accordance with ASTM D2732. The results are reported in Table 5 below.

TABLE 5

| | Pre-heat/ | Free |
|---|---|---|
| Sample | Bath Temp (° F.) | Shrink (%) |
| Film 1 | 200/200 | 78/84 |
| | 195/195 | 84/88 |
| | 190/190 | 87/86 |
| Film 2 | 200/200 | 74/72 |
| | 195/195 | 81/78 |
| | 190/190 | 87/87 |

As shown in Table 5, Film 2 has nearly the same free shrink as comparative film 1. Thus, the processing aid did not have an adverse effect on free shrink.

The films were also compared for the oxygen transmission rate. All data was collected in accordance with ASTM D3985 as shown in Table 6.

TABLE 6

| | Ave. OTR 100% in/50% out RH | Ave. OTR 90% RH |
|---|---|---|
| | (cc/m² · d · atm) | (cc/m² · d · atm) |
| Film 1 | 2.44 | 11.7 |
| Film 2 | 3.68 | 16.8 |

As shown in Table 6, the processing aid had only a minor impact on the oxygen transmission rate of the film.

Additional films were made as shown in Table 7.

TABLE 7

| | Layer 1 | Layer 2 | Layer 3 | Layer 4 | Layer 5 |
|---|---|---|---|---|---|
| Film 3 | 80% | 100% | 100% | 100% | 80% |
| | VLDPE | VLDPE-md | EVOH3 | VLDPE-md | VLDPE |
| .58 mils | 20% | | | | 20% |
| | LLDPE | | | | LLDPE |
| Thickness | 27.3% | 9.1% | 27.3% | 9.1% | 27.3% |
| (%) | | | | | |
| Film 4 | 80% | 100% | 95% | 100% | 80% |
| | VLDPE | VLDPE-md | EVOH3 | VLDPE-md | VLDPE |
| .58 mils | 20% | | 5% | | 20% |
| | LLDPE | | triacetin | | LLDPE |
| Thickness | 27.3% | 9.1% | 27.3% | 9.1% | 27.3% |
| (%) | | | | | |

Films 3 and 4 were tested for oxygen transmission rate (OTR) in accordance with ASTM D-3985 at standard temperature and pressure.

TABLE 8

| | Avg. OTR 0% RH | Avg. OTR 90% RH |
|---|---|---|
| | (cc/m2 · d · atm) | (cc/m2 · d · atm) |
| Film 3 (C) | 3.46 + 0.14 | 45.4 + 5.8 |
| Film 4 | 2.97 + 1.23 | 40.1 + 4.5 |

As shown in Table 8 the processing aid had only a minor impact on the oxygen transmission rate of the film at various relative humidity.

Additional films were made as shown in Table 9.

TABLE 9

| | Layer 1 | Layer 2 | Layer 3 | Layer 4 | Layer 5 | Layer 6 | Layer 7 | Layer 8 | Layer 9 | Layer 10 |
|---|---|---|---|---|---|---|---|---|---|---|
| Film 5 (C) | 80% | 50% | 80% | 100% | 80% | 50% | 80% | 100% | 80% | 100% |
| | VLDPE | VLDPE | LLDPE | EVOH3 | LLDPE | VLDPE | LLDPE | EVOH3 | LLDPE | EPC |
| 1.77 mils | 20% | 50% | 20% | | 20% | 50% | 20% | | 20% | |
| | LLDPE | EVA | VLDPE- | | VLDPE- | EVA | VLDPE- | | VLDPE- | |
| | | | md | | md | | md | | md | |
| Thickness | 20 | 15 | 8 | 4 | 8 | 15 | 8 | 4 | 8 | 10 |
| (%) | | | | | | | | | | |
| Film 6 | 80% | 50% | 80% | 92% | 80% | 50% | 80% | 92% | 80% | 100% |
| | VLDPE | VLDPE | LLDPE | EVOH3 | LLDPE | VLDPE | LLDPE | EVOH3 | LLDPE | EPC |
| 1.77 mils | 20% | 50% | 20% | 8% | 20% | 50% | 20% | 8% | 20% | |
| | LLDPE | EVA | VLDPE- | triacetin | VLDPE- | EVA | VLDPE- | triacetin | VLDPE- | |
| | | | md | | md | | md | | md | |
| Thickness | 20 | 15 | 8 | 4 | 8 | 15 | 8 | 4 | 8 | 10 |
| (%) | | | | | | | | | | |
| Film 7 | 80% | 50% | 80% | 100% | 80% | 50% | 80% | 100% | 80% | 100% |
| (C) | VLDPE | VLDPE | LLDPE | EVOH4 | LLDPE | VLDPE | LLDPE | EVOH4 | LLDPE | EPC |
| 1.77 mils | 20% | 50% | 20% | | 20% | 50% | 20% | | 20% | |
| | LLDPE | EVA | VLDPE- | | VLDPE- | EVA | VLDPE- | | VLDPE- | |
| | | | md | | md | | md | | md | |
| Thickness | 20 | 15 | 8 | 4 | 8 | 15 | 8 | 4 | 8 | 10 |
| (%) | | | | | | | | | | |
| Film 8 | 80% | 50% | 80% | 92% | 80% | 50% | 80% | 92% | 80% | 100% |
| | VLDPE | VLDPE | LLDPE | EVOH4 | LLDPE | VLDPE | LLDPE | EVOH4 | LLDPE | EPC |
| 1.77 mils | 20% | 50% | 20% | 8% | 20% | 50% | 20% | 8% | 20% | |
| | LLDPE | EVA | VLDPE- | triacetin | VLDPE- | EVA | VLDPE- | triacetin | VLDPE- | |
| | | | md | | md | | md | | md | |
| Thickness | 20 | 15 | 8 | 4 | 8 | 15 | 8 | 4 | 8 | 10 |
| (%) | | | | | | | | | | |

CO₂ and O₂ transmission rates were tested for films 5-8. The tests were conducted at 73° F. and 0% relative humidity. CO₂ Transmission Rate is measured in accordance with ASTM F2476 and O₂ Transmission Rate is measured in accordance with ASTM D-3985.

TABLE 10

| | CO₂ Transmission | O₂ Transmission | |
|---|---|---|---|
| | Rate | Rate | |
| | (cc-25.4 micron/ | (cc-25.4 micron/ | CO₂/O₂ TR |
| | m2 · d · atm | m2 · d · atm | ratio |
| Film 5 (C) | 1.27 | 1.1 | 1.2 |
| Film 6 | 2.73 | 1.49 | 1.8 |
| Film 7 (C) | 2.17 | 0.82 | 2.6 |
| Film 8 | 5.25 | 1.73 | 3 |

As shown in Table 10 Films 6 and 8 had a small impact on CO₂ and O₂ transmission rates as compared to Films 5 and 8 respectively. Surprisingly, the processing aids improved the CO₂/O₂ Transmission Rate ratio (CO₂/O₂ TR ratio). The CO₂/O₂ TR ratio is calculated by the formula of:

CO₂ Transmission Rate÷O₂ Transmission Rate=CO₂/O₂ TR ratio

A series of 9-layer cast films structure were prepared as shown in Table 11.

TABLE 11

| | Layer 1 | Layer 2 | Layer 3 | Layer 4 | Layer 5 | Layer 6 | Layer 7 | Layer 8 | Layer 9 |
|---|---|---|---|---|---|---|---|---|---|
| Film 9 | 96% | 100% | 100% | 70% | 100% | 70% | 100% | 100% | 100% |
| | VLDPE | LLDPE | LLDPE- | PA-6 | EVOH1 | PA-6 | LLDPE- | EPC | PP |
| | | | md | | | | md | | |
| 7.0 mils | 4% AB | | | 30% | | 30% | | | |
| | | | | PA-6\66 | | PA-6\66 | | | |
| Thickness | 8 | 17 | 8 | 13.5 | 9 | 13.5 | 7 | 16 | 8 |
| (%) | | | | | | | | | |
| Film 10 | 96% | 100% | 100% | 70% | 95% | 70% | 100% | 100% | 100% |
| | VLDPE | LLDPE | LLDPE- | PA-6 | EVOH1 | PA-6 | LLDPE- | EPC | PP |
| | | | md | | | | md | | |
| 1.77 mils | 4% AB | | | 30% | 5% | 30% | | | |
| | | | | PA-6\66 | triacetin | PA-6\66 | | | |
| Thickness | 8 | 17 | 8 | 13.5 | 9 | 13.5 | 7 | 16 | 8 |
| (%) | | | | | | | | | |
| Film 11 | 96% | 100% | 100% | 70% | 90% | 70% | 100% | 100% | 100% |
| | VLDPE | LLDPE | LLDPE- | PA-6 | EVOH1 | PA-6 | LLDPE- | EPC | PP |
| | | | md | | | | md | | |
| 1.77 mils | 4% AB | | | 30% | 10% | 30% | | | |
| | | | | PA-6\66 | triacetin | PA-6\66 | | | |
| Thickness | 8 | 17 | 8 | 13.5 | 9 | 13.5 | 7 | 16 | 8 |
| (%) | | | | | | | | | |
| Film 12 | 96% | 100% | 100% | 70% | 100% | 70% | 100% | 100% | 100% |
| | VLDPE | LLDPE | LLDPE- | PA-6 | EVOH6 | PA-6 | LLDPE- | EPC | PP |
| | | | md | | | | md | | |
| 1.77 mils | 4% AB | | | 30% | | 30% | | | |
| | | | | PA-6\66 | | PA-6\66 | | | |
| Thickness | 8 | 17 | 8 | 13.5 | 9 | 13.5 | 7 | 16 | 8 |
| (%) | | | | | | | | | |
| Film 13 | 96% | 100% | 100% | 70% | 95% | 70% | 100% | 100% | 100% |
| | VLDPE | LLDPE | LLDPE- | PA-6 | EVOH6 | PA-6 | LLDPE- | EPC | PP |
| | | | md | | | | md | | |
| 1.77 mils | 4% AB | | | 30% | 5% | 30% | | | |
| | | | | PA-6\66 | triacetin | PA-6\66 | | | |
| Thickness | 8 | 17 | 8 | 13.5 | 9 | 13.5 | 7 | 16 | 8 |
| (%) | | | | | | | | | |

Oxygen transmission rate (OTR) and permeability were determined under two conditions, 0% RH in and out (0/0) and 90% RH in and out (90/90) and reported below in Table 12. Oxygen transmission rate was measured in accordance with ASTM D3985, which is hereby incorporated, in its entirety, by reference thereto. Permeability was measured in accordance with ASTM F1927, which is hereby incorporated, in its entirety, by reference thereto.

TABLE 12

| | | | OTR | | | Permeability |
|---|---|---|---|---|---|---|
| | | OTR 0/0 | 90/90 | Barrier | Permeability | 90/90 |
| | | (cc/m²- | (cc/m²- | Thickness | 0/0 (cc-mil/ | (cc-mil/ |
| Film | Barrier Layer | d-atm) | d-atm) | (actual mil) | m²-d-atm) | m²-d-atm) |
| Film 9 | EVOH1 | 1.17 | 10.7 | 0.75 | 0.88 | 8.06 |
| Film 10 | EVOH1 + 5% triacetin | 2.01 | 17.5 | 0.66 | 1.33 | 11.52 |
| Film 11 | EVOH1 + 10% triacetin | 2.82 | 21.4 | 0.6 | 1.69 | 12.84 |
| Film 12 | EVOH6 | 0.31 | 15.2 | 0.73 | 0.22 | 11.06 |
| Film 13 | EVOH6 + 5% triacetin | 0.48 | 19.2 | 0.6 | 0.29 | 11.54 |

Impact properties of films were measured on an Instron 9340 and the results reported in Table 13. Instrumented impact was measured with a dart drop in accordance with ASTM D 3763, which is hereby incorporated, in its entirety, by reference thereto. Slow puncture was measured according to ASTM F1306 using a crosshead speed of 1 inch per minute.

TABLE 13

| | Instrumented Impact | | | Slow Puncture | | |
|---|---|---|---|---|---|---|
| | (dart drop) | | | (1 in/min) | | |
| | Average | Peak | Total | Average | Load at | Total |
| | Gauge | Force | Energy | Gauge | Break | Energy |
| Film | (mil) | (N) | (J) | (mil) | (lb.) | (lb-in) |
| Film 9 | — | — | — | 7.13 | 12.0 | 3.93 |
| Film 10 | — | — | — | 7.29 | 9.17 | 2.20 |
| Film 11 | — | — | — | 7.05 | 10.8 | 3.16 |
| Film 12 | 7.09 | 181.9 | 1.94 | 7.01 | 10.4 | 2.69 |
| Film 13 | 7.29 | 187.2 | 2.14 | 7.19 | 10.1 | 2.66 |

Optical properties were measured and reported in Table 14. Film clarity was measured in accordance with ASTM D 1746-97 “Standard Test Method for Transparency of Plastic Sheeting”, published April, 1998, which is hereby incorporated, in its entirety, by reference thereto. Film haze values were measured in accordance with ASTM D 1003-00 “Standard Test Method for Haze and Luminous Transmittance of Transparent Plastics”, published July 2000, which is hereby incorporated, in its entirety, by reference thereto.

TABLE 14

| | Average Gauge | Clarity | Haze |
|---|---|---|---|
| Film | (mil) | (%) | (%) |
| Film 12 | 7.22 | 24.3 | 3.7 |
| Film 13 | 6.71 | 23.5 | 2.4 |

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

### PARTS LIST

10 extruders
11 polyamide
12 head
14 tubing
16 cooling ring
18 pinch rolls
20 irradiation vault
22 shielding
24 iron core transformer accelerator
26 rolls
28 tubing
30 windup roll
32 irradiated tubing tape coil
34 unwind roll
36 unwind tubing tape coil
38 guide roll
40 hot water bath tank
42 hot water
44 tubular tape
46 nip rolls
46 pinch rolls
48 bubble
50 film tube
52 nip rolls
54 parallel rollers
56 guide roll
58 wind-up roll
60 idler roll
62 bag
64 film
66 open top
68 bottom
70 end-seal
72 packaged meat product
74 packaged product
76 clips
78 casing film
80 inside surface
81 seals
82 outside surface
84 heat seal
86 inside surface
88 butt-seal tape
90 outside surface
92 inside surface
94 seal
139 extruder
530 extruder
531 die
531 annular die
532 screen pack
533 breaker plate
534 heaters
535 mandrel
536 air ring
537 bubble
538 guide rolls
539 nip rolls
540 treater bar
541 idler rolls
542 dancer roll
543 film tubing
544 roll
545 winder

1. A multilayer film comprising a first outer layer, a second outer layer and a barrier layer disposed between the first outer layer and the second outer layer, the barrier layer comprising a blend of:
a. at least 90.0% ethylene vinyl alcohol copolymer having a first crystallization temperature; and
b. between (i) 2.0 wt % and 15.0 wt %, (ii) 2.5 wt % and 10.0 wt %, or (iii) 3.0 wt % and 5.0 wt % of a processing aid as compared to the barrier layer,
the blend having a second crystallization temperature that is at least 5%, 6%, 7%, 8%, 9%, or 10% lower than the first crystallization temperature as measured by DSC with the following parameters:
a) hold for 1.0 min at 30° C.;
b) heat from 30.0° C. to 230.0° C. at 10.0° C./min;
c) hold for 1.0 min at 230.0° C.;
d) cool from 230.0° C. at 10.0° C./min;
e) hold for 1.0 min at 30.0° C.;
f) Heat from 30.0° C. to 230.0° C. at 10.0° C./min.

2. The multilayer film of claim 1 wherein the ethylene vinyl alcohol copolymer has a first ΔH_{c} and the blend has a second ΔH_{c} which is at least 70%, 75% 80%, 85%, 90%, 95%, 100%, 105%, 110%, 115% or 120% the first ΔH_{c}.

3. The multilayer film of claim 1 wherein the ethylene vinyl alcohol copolymer has an ethylene content of not more than 40 mol %.

4. The multilayer film of claim 1 wherein the processing aid is selected from the group consisting of triacetin, diacetin, lactic acid, triethyl citrate and glycerin carbonate.

5. The multilayer film of claim 1 wherein the multilayer film is a heat shrinkable multilayer film having a total free shrink at 185° F. of at least 30 percent as measured in accordance with ASTM D 2732.

6. The multilayer film of claim 1 comprising at least two barrier layers.

7. The multilayer film of claim 6 wherein the multilayer film comprises a layer disposed between the at least two barrier layers.

8. The multilayer film of claim 1 wherein the processing aid comprises:
a. at least one ester,
b. at least one carboxylic acid or carbonate functional group, and
c. at least one hydroxyl functional group.

9. The multilayer film of claim 1 wherein the barrier layer comprises less than 1.0 wt % salts based on the composition of the barrier layer.

10. The multilayer film of claim 1 wherein the barrier layer comprises 0.0-1.0 wt % of material other and ethylene vinyl alcohol copolymer and processing aid.

11. The multilayer film of claim 1 wherein the film has an oxygen transmission rate of no more than: 5, 10, 15, 20, 25, 30, 35, 40, 45, 50, 55, 60, 65, 70, 75, 80, 85, 90, 95, 100, 105, 110, 115, 120, 125, 130, 135, 140, 145 or 150 cubic centimeters (at standard temperature and pressure) per square meter per day per 1 atmosphere of oxygen pressure differential measured at 0% relative humidity and 23° C. measured according to ASTM D-3985.

12. (canceled)

13. The multilayer film of claim 1 wherein the processing aid is between 2.0 wt % and 10.0 wt %, as compared to the barrier layer, of triethyl citrate or triacetin.

14. The multilayer film of claim 1 wherein at least a portion of the film is crosslinked.

15. The multilayer film of claim 1 wherein the ethylene vinyl alcohol copolymer has a first ΔHₘ and the blend has a second ΔHₘ which is at least 70%, 75% 80%, 85%, 90%, 95%, 100%, 105%, 110%, 115% or 120% the first ΔHₘ.

16. The multilayer film of claim 1 wherein the film has a transparency of at least 15 percent, or at least 20 percent, or at least 25 percent, or at least 30 percent, measured using ASTM D 1746-97.

17. The multilayer film of claim 1 wherein the film has a haze of less than 7.5 percent, or less than 7 percent, or less than 6 percent, measured using ASTM D 1003-00.

18. The multilayer film of claim 1 wherein the film has a gloss, as measured using ASTM D 2457-97, of from 60% to 100%, or from 70% to 90%.

19. The multilayer film of claim 1 wherein the film has a CO₂/O₂ Transmission Rate ratio of between 1.5 and 3.0 wherein CO₂ Transmission Rate is measured in accordance with ASTM F2476 O₂ Transmission Rate is measured in accordance with ASTM D-3985 at standard pressure, 73° F. and 0% relative humidity.

20. A blend of ethylene vinyl alcohol copolymer and processing aid comprising:
a. at least 90.0% ethylene vinyl alcohol copolymer having a first crystallization temperature; and
b. between (i) 2.0 wt % and 15.0 wt %, (ii) 2.5 wt % and 10.0 wt %, or (iii) 3.0 wt % and 5.0 wt % of a processing aid as compared to the blend,
the blend having a second crystallization temperature that is at least 5%, 6%, 7%, 8%, 9%, or 10% lower than the first crystallization temperature as measured by DSC with the following parameters:
a) hold for 1.0 min at 30° C.;
b) heat from 30.0° C. to 230.0° C. at 10.0° C./min;
c) hold for 1.0 min at 230.0° C.;
d) cool from 230.0° C. at 10.0° C./min;
e) hold for 1.0 min at 30.0° C.;
f) Heat from 30.0° C. to 230.0° C. at 10.0° C./min.

21-29. (canceled)

30. A process for making a multilayer film comprising the steps of:
a. providing a barrier blend comprising:
i. at least 90.0% ethylene vinyl alcohol copolymer having a first crystallization temperature; and
ii. between (i) 2.0 wt % and 15.0 wt %, (ii) 2.5 wt % and 10.0 wt %, or (iii) 3.0 wt % and 5.0 wt % of a processing aid as compared to the barrier blend,
the blend having a second crystallization temperature that is at least 5%, 6%, 7%, 8%, 9%, or 10% lower than the first crystallization temperature as measured by DSC with the following parameters:
a) hold for 1.0 min at 30° C.;
b) heat from 30.0° C. to 230.0° C. at 10.0° C./min;
c) hold for 1.0 min at 230.0° C.;
d) cool from 230.0° C. at 10.0° C./min;
e) hold for 1.0 min at 30.0° C.;
f) Heat from 30.0° C. to 230.0° C. at 10.0° C./min,
b. coextruding the barrier blend to form a multilayer film having a first outer layer, a second outer layer and the barrier blend disposed as a layer between the first outer layer and the second outer layer.

31-38. (canceled)
